(19) United States
(12) Patent Application Publication
(10) Pub. No.: US 2003/0038534 A1
(43) Pub. Date: Feb. 27, 2003

(54) Intelligent brake controller for use with towed trailer braking systems

(76) Inventor: William Lunceford Barnett, Colleyville, TX (US)

Correspondence Address: JENKENS & GILCHRIST, PC, 1445 ROSS AVENUE, SUITE 3200, DALLAS, TX, 75202, US

(21) Appl. No.: 09/938,001

(22) Filed: Aug. 22, 2001

(51) Int. Cl. B60T 13/00

(52) U.S. Cl. 303/7

(57) ABSTRACT

A brake controller system for a towing vehicle and a towed vehicle. The system has a brake control unit that controls a brake activator. The brake control unit takes various data readings, which may include temperature of the brake activator and brake fluid pressure. The system then calculates an appropriate amount of brake force and determines whether to supply additional voltage with a voltage booster.

### RELATED APPLICATION(S)

This application relates to and claims priority from provisional application Serial No. ______ filed on Aug. 22, 2000.

### TECHNICAL FIELD

The present invention relates to towed vehicle electric or hydraulic brake systems. More particularly, the present invention relates to a microprocessor operated towed vehicle brake controller that operates by measuring various electrical input signals. The invention then processes this information along with internally programmed information and sends braking signals to the towed vehicle braking system.

### BACKGROUND OF THE INVENTION

A problem with typical electric brakes for use with a towed vehicle, such as a trailer, is that current brake controllers oftentimes cannot send sufficient current to the electric trailer brakes to supply adequate braking force to the trailer. The primary reason for limited braking capacity of existing brake controllers is that typical controllers are limited to a twelve (12) volt supply voltage. The twelve (12) volt limitation limits the amount of electrical current that the controllers can supply to electric brakes. The limitation on electrical current supplied to the electric brakes limits the total amount of power that the electric brakes can apply for braking. Typical prior art controllers use a decelerometer to sense when the towed vehicle is beginning to brake. When braking occurs in the towing vehicle, the decelerometer detects towing vehicle deceleration and sends a stop signal to the towed trailer brakes. Therefore, there is a delay in the application of the trailer brakes along with the possibility that the rate of braking for the trailer is inconsistent with the towed vehicle rate of braking.

### SUMMARY OF THE INVENTION

Unlike current towed vehicle controls, the controller of the embodiments of the present invention uses actual towing vehicle braking information, instead of decelerometers, to calculate the braking signal to be sent to towed vehicle braking system. The brake controller of the current invention can use up to a twenty-four (24) volt power supply and is a constant current device that regulates voltage to supply a constant current for the desired braking. Regulating voltage to supply a constant current compensates for brake heating due to brake friction and current flow through the electric brake electromagnet wire coils. The exemplary brake controller has a pressure sensor installed in the towing vehicle brake system master cylinder. This sensor detects pressure increases and decreases caused by operator application of the towing vehicle brake system. These pressure signals are in turn used by the exemplary brake controller to calculate the amount of signal to send to the trailer brakes.

The operation of embodiments of this invention can be separated into five main functions. These are: first, operator programming and setup of the invention; second, data detection by the invention of various input parameters including vehicle equipment characteristics; third, self-programming based upon operator programming and data input; fourth, control by the invention of the towed vehicle brakes; and fifth, the storage of manufacturing information and usage information.

There are a number of parameters that can be input into the exemplary intelligent brake controller. These parameters include gain or braking intensity, which means the rate at which the brakes are applied. The operator can input the date and time and make a manual request for error codes from compatible computerized braking systems.

The exemplary intelligent brake controller has automatic detection features. These detection features include automatic detection of the type of the towed vehicle, i.e., trailer, brake system, and whether the brake system is electric or hydraulic. If the towed vehicle has electric brakes, the intelligent brake controller will detect the number of trailer axles with electric brakes by conducting an induction test over the towed vehicle braking voltage/signal connection and connection of the towing vehicle battery ground. With this test the brake controller of the invention will detect the presence of electric brakes and the number of electric brake equipped axles.

After detecting the presence of electric brakes and counting the number of electric brake equipped axles, the exemplary intelligent brake controller will self-program itself to operate these types of brakes. If the invention detects the presence of hydraulic brakes, it will program itself to operate hydraulic brakes.

The exemplary intelligent brake controller will also detect whether a voltage booster is connected to the controller. When the intelligent brake controller detects inadequate braking from towed vehicle electric brakes, the invention can supply an additional 12 volts to the electric brakes, thereby yielding a total voltage supply of 24 volts to electric brakes. Inadequate braking may be due to the heating of magnets that may be used within a brake activator. As the magnets heat up, braking power may be diminished. The ability to boost the voltage enables a braking system to have constant current control. By controlling the current voltage, brake fade can be eliminated. The voltages listed are typical of electric brake systems. However, embodiments of the invention could easily be adapted to other voltages and voltage boosts.

The exemplary intelligent brake controller continuously monitors towing vehicle master cylinder pressure and uses this information to control the towing vehicle brakes. The intelligent brake controller of the invention does this by monitoring a pressure signal from a pressure sensor. When the intelligent brake controller senses a pressure increase in the towing vehicle master cylinder due to the application of the towed vehicle brakes, the intelligent brake controller sends a signal to the towed vehicle brakes to start applying the towed vehicle brakes. The intelligent brake controller modulates the signal sent to the brakes such that the towed vehicle brakes are applied in direct proportion to the amount of brake application in the towing vehicle. In this way the towed vehicle brakes will be applied in the same manner and at the same time as brakes of the towing vehicle.

The exemplary intelligent brake controller of the invention has a manual override feature. The towed vehicle brakes can be applied through the operator use of a manual thumb brake switch. The manual thumb brake switch is a sliding switch that may be depressed longitudinally within the intelligent brake controller housing. A signal is generated based upon and directly proportional to the linear position of the manual brake switch. This proportional signal is sent to the towed vehicle brakes, applying those brakes proportionally to the intelligent brake controller signal.

The exemplary intelligent brake controller of the invention will store in electronic memory, more specifically in programmable non-volatile memory, manufacturing and usage information on itself. Part of the intelligent brake controller intelligence is its ability to monitor and record the current date and time. The exemplary intelligent brake controller has an internal clock and calendar that continuously work to keep track of the current date and time. In the absence of external power, an internal battery powers the internal clock and calendar. Access to date and time information will allow the exemplary intelligent brake controller to record its own manufacturing date and in service date. Because the exemplary intelligent brake controller can also detect the number of operations that it has undergone, it will be able to record a number of cycles that will signal the beginning of a warranty period.

Current laws may require that all trailer brakes have a safety feature such that if the trailer is separated unexpectedly from the towing vehicle the trailer brakes will automatically be applied. This feature is referred to as the breakaway mode. Embodiments of the invention may record critical breakaway information, such as proof of breakaway and date and time of breakaway and pressure applied during breakaway. The intelligent brake controller will then be able to retrieve, save and display these data. Preferably, an intelligent hydraulic actuator is located on the towed vehicle to facilitate these operations.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a schematic view of a towing vehicle and towed vehicle.

FIG. 2 is a front perspective view of the intelligent brake controller that illustrates the control buttons and display bezel.

FIG. 3 is a rear elevational view of the back of the intelligent brake controller that shows a detail of the individual electrical connections to the intelligent brake controller.

FIG. 4 is a schematic view of the intelligent brake controller and input devices.

FIG. 5 is a flowchart that illustrates a logic sequence used by the invention.

### DETAILED DESCRIPTION OF THE PREFERRED EMBODIMENTS OF THE PRESENT INVENTION

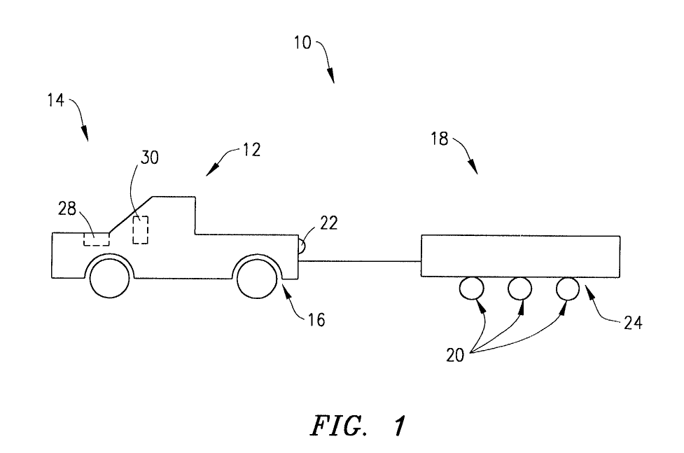

Referring now to FIGS. 1-4 an exemplary intelligent brake controller system 10 is shown. The brake intelligent system 10 is utilized by a towing vehicle 12 (FIG. 1) having a towing vehicle brake system 14 for operating towing vehicle brakes 16. Towing vehicle brake system 14 is typically a hydraulic brake system actuated by a master cylinder (not shown). A towed vehicle 18 having towed vehicle brakes 20 is also used by the intelligent brake controller system 10. Preferably, the towed vehicle brakes are electric brakes utilizing electric brake activator 24 to activate the towed vehicle brakes 20. Brake lights 22 are located on towed vehicle 18. Brake lights 22 illuminate when the towed vehicle brakes 20 are activated. In the preferred embodiment, the brake activator 24 comprises a magnet which is used to apply force to the towed vehicle brakes 20. In a preferred embodiment, brake activator 24 is an intelligent brake activator capable of recording critical breakaway information. A pressure sensor 28 is provided in the towing vehicle 12 proximate the master cylinder of towing vehicle 12 for measuring pressure of brake fluid within the towing vehicle brake system 14.

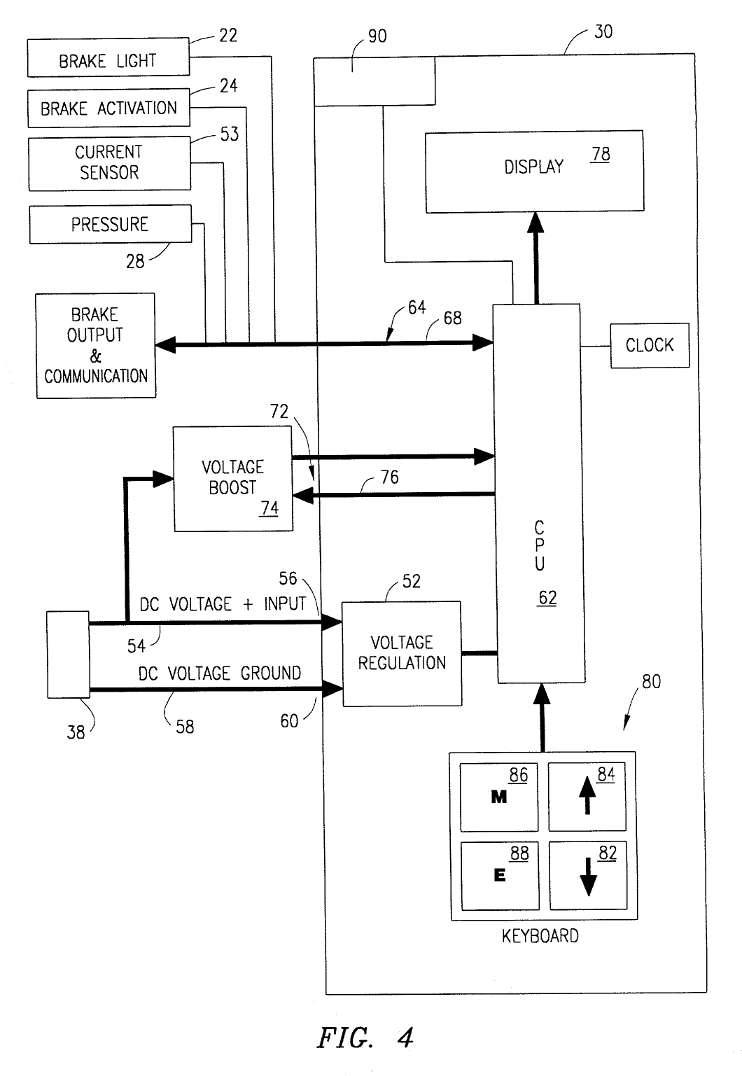

The electric brake control unit 30 is preferably located within a interior of towing vehicle 12. The electric brake control unit 30 (FIGS. 1-4) is provided with a brake controller housing 32. A battery 38 (FIG. 4) is provided to supply power to the towed vehicle 18 and to the electric brake control unit 30.

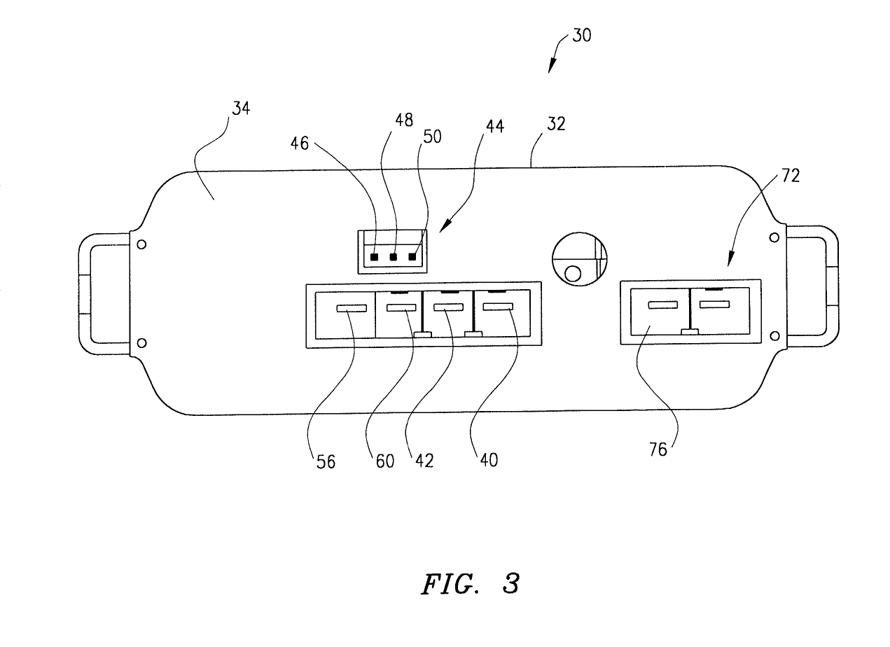

The electric brake controller housing 32 has a rear face 34 and a front face 36. A brake light connection 40 (FIG. 3) is provided on rear face 34 of the brake controller housing 32 for transmitting a signal to illuminate the towed vehicle brake lights 22. A brake actuating signal connection 42 is provided on rear face 34 of brake controller housing 32 for facilitating the transmission of a signal to actuate the electric brake activator 24 for activating the towed vehicle brakes 20. A pressure sensor input connector 44 (FIG. 3) is preferably provided on rear face 34 of the brake controller housing 32. In a preferred embodiment, the pressure sensor input connector 44 has a first lead 46, a second lead 48 and a third lead 50 for receiving information from pressure sensor 28.

A preferred embodiment brake control unit 30 has voltage regulation circuitry 52 (FIG. 4). A current sensor 53 senses amperage from electric brake control unit 30 and signals electric brake control unit 30 to maintain a consistent amperage from brake control unit 30. A 12 volt DC input wire 54 provides electrical communication from battery 38 to the voltage regulation circuitry 52. A 12 volt connection 56 (FIG. 3) is provided on the rear face 34 of the brake controller housing 32 for receiving a towing vehicle positive 12 volt connection from voltage regulation circuitry 52. The 12 volt DC ground wire 58 provides electrical communication from the battery 38 to the voltage regulation circuitry 52. Ground connection 60 (FIG. 3) is preferably provided on the rear face 36 of the brake controller housing 32 for receiving the battery ground wire 58.

Referring now to FIG. 4, a central processing unit (CPU) 62 is preferably provided within the brake controller housing 32 for controlling the operations of the brake controller unit 30. The CPU 62 receives power from the battery 38 via the voltage regulation circuitry 52. A bus 64 is provided for communicating signals from CPU 62 to various components of the brake controller system 10. For example, signals are sent over bus 64 to brake lights 22, the electric brake activator 24, the temperature sensor 26 and the pressure sensor 28. In a preferred embodiment, bus 64 is at least one brake wire 68 that is in electrical communication with the CPU 62, with brake lights 22, the electric brake activator 24, temperature sensor 26 and pressure sensor 28. A 24 volt receiving connection 72 (FIG. 3) is preferably provided on a rear face 34 of the brake controller housing 32. Voltage booster 74 (FIG. 4) is provided that is in electrical communication with the battery 38 via the 12 volt DC input line 54. The voltage booster 74 is also in electrical communication with the CPU 62. A voltage doubler connection 76 is preferably provided on rear face 34 of the brake controller housing 32 for facilitating the signaling of voltage booster 74 so that voltage booster 74 may supply an additional 12 volts to the 24 volt receiving connection for activating brake activator 24.

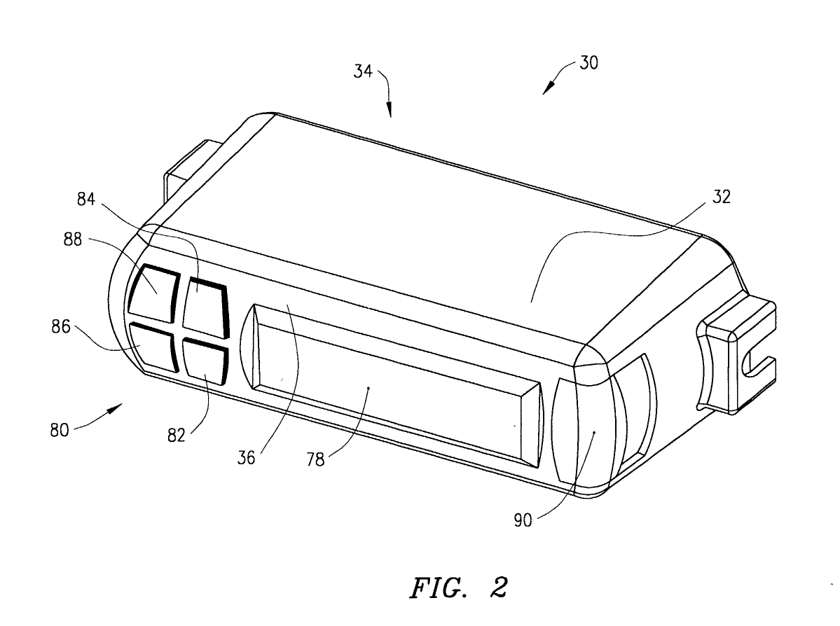

A display 78 (FIGS. 2 and 4) is provided on the front face 36 of the brake controller housing 32. Display 78 is in electrical communication with the CPU 62. Display 78 is for use as a visual indicator to an operator of the towing vehicle 12. Additionally, display 78 serves as a response indicator to the operator during programming of the brake control unit 30. A control panel 80 (FIGS. 2 and 4) is preferably provided on front face 36 of the brake controller housing 32. Control panel 80 is used to scroll through and make selections of a menu that is displayed on the display 78. Still referring to FIGS. 2 and 4, in a preferred embodiment, the control panel 80 comprises an adjust selection display down button 82, an adjust selection display up button 84, an enter selection display button 86 and a scroll menu button 88. Additionally, in a preferred embodiment, a manual thumb brake switch 90 is provided on the electrical brake control unit 30. Preferably the manual thumb brake switch 90 is a sliding switch that may be depressed longitudinally within the brake controller housing.

In practice, the brake controller system 10 is utilized by actuating the towed vehicle brakes 20 independently of a towing vehicle foot brake and preferably without actuating the towing vehicle brakes 16 by utilizing manual thumb brake switch 90 If needed, manual thumb brake switch 90 is used to generate a signal that is based upon and is directly proportional to the linear position of the manual thumb brake switch 90. The manual thumb brake switch 10 is used independently of the towing vehicle foot brake and allows the operator to actuate the trailer brakes without actuation of the towing vehicle brakes.

Display 78 displays alphanumeric data for use as a visual indicator to the vehicle operated during operation of the brake controller unit 30. Additionally, the display 78 displays alphanumeric data as a response indicator to the operator during programming of the intelligent brake control unit 30. For example, the display 78 may be used to display at least the following signals: “adjust initial brake gain”, “set time: set hours and minutes”, “set date: set month, day and year”, “display last: maximum brake”, “display last: maximum stroke”, “last test: maximum brake”, “last test: maximum stroke”, “truck control: serial number”, “truck control: date manufactured”, “truck control: born on date”, “trailer control: serial number”, “trailer control: date manufactured”, “trailer control: born on date”, “run diagnostic: test brakes”. An operator may then scroll through and make selections from a menu displayed on the display 78 by manipulating buttons 82, 84, 86 and 88. During operation, if additional braking power is required, the electric brake control unit 30 will signal the voltage booster 74 via the voltage doubler connection 76 to supply an additional 12 volts above the towing vehicle's standard 12 volts. In a preferred embodiment, this will yield a total of 24 volts that are supplied to the intelligent brake controller unit 30. The intelligent brake control 30 then actuates the towed vehicle brakes 20 via the brake actuating signal connection 42. Towed vehicle brake lights 20 are activated via the brake light connection 40. The brake fluid pressure within the towing vehicle brake system 14 is sent with pressure sensor 28. Additionally, the temperature of the collective brake activators 24 are sensed with temperature sensor 26.

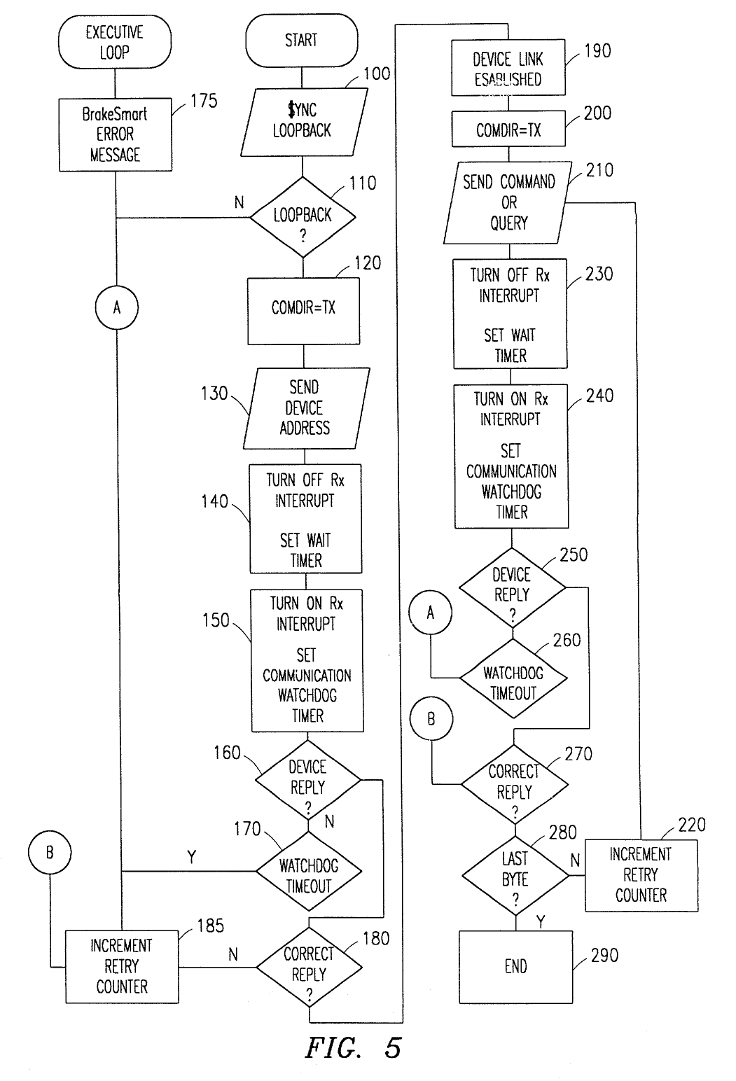

Referring now primarily to FIG. 5, the communication logic from the CPU 62 to various devices of the brake control system 10 will be discussed. The brake control 30 uses brake wire(s) 68 having a ground wire as a communication bus 64 to other intelligent devices located on a trailer or towed vehicle 18. A single active wire 68 communication scheme sequentially and serially transmits and receives information to multiple devices on the bus 64. Communication from the brake control unit 30 to other devices over bus 64 is controlled by first sending out a sync loopback (a sync signal) as illustrated by box 100 (see FIG. 5) over bus 64 to alert all devices of pending communication. The brake control unit 30 then determines whether a loopback situation has occurred as illustrated in box 110. A loopback situation occurs when the intelligent brake controller 30 receives an acknowledgment from the towed vehicle braking apparatus 24. This occurs in response to an address query transmission from the intelligent brake controller 30. The CPU 62 then sends the device address for the particular device as illustrated in box 130. CPU 62 then turns off a receive interrupt and sets a wait timer as illustrated in box 140. After the receive interrupt lockout has timed out, the CPU 62 waits for acknowledgment from the specified device address as illustrated in box 160. Additionally, a watchdog timer is set by CPU 62. If the acknowledgment from the device address is unsuccessful, as determined in box 180, the CPU 62 increments the retry counter as indicated in box 185 and the process begins again at box 110. Similarly, if no device reply is received prior to the watchdog timeout, as indicated in box 170, then the process begins again at box 110. However, if the expected reply is received as illustrated in box 180, then a device link within CPU 62 determines that a device link has been established as illustrated in box 190, as illustrated in box 200. A device link is established when the intelligent brake controller 30 transmits a signature address query and receives a matching address echo from an intelligent braking device 24 on the towed vehicle 18. CPU 62 then sends out either a query byte or a series of command bytes depending upon the desired task of the target address device as illustrated in box 210. If a query byte is transmitted, then the transmission in the received protocol is checked, so that the transmission process continues until the end of the byte process occurs. A transmission end received protocol is checked after each byte. The procedure assures that the receiving device echos the byte transmitted back to the CPU 62. Failure of either the CPU 62 or of the remote device to agree on the byte will cause the communication process to restart. This can occur 5 at any point in the data transmission and provides an instant method of determining error. This process is facilitated by sending the query byte or command bytes as discussed above with reference to box 210. The receive interrupt is then turned off and a wait timer is set as illustrated in box 230. After the receive interrupt lockout has timed out, the receive interrupt is turned on and a communication watchdog timer is set as illustrated in box 240. CPU 62 then determines if a device reply was received as illustrated in box 250. If the reply was not received, then the watchdog times out the process as illustrated in box 260 and the process begins again at box 110. If an unexpected reply was received by CPU 62 as illustrated in box 270, then the process will begin again at box 110. CPU 62 then determines whether the last byte has been received as illustrated in box 280. If not, then the command byte counter is incremented in box 220 and a new command or query may be issued as indicated in box 210. If so, the process is concluded as illustrated in box 290.

An alternate protocol may be used to check data as a string of bytes at the end of the communication process. The one advantage with such a procedure is that it allows for undesired delay of communication errors to be detected, although the byte by byte acknowledgment is a relatively labor intensive task. However, the transmission as received acknowledgment check allows a throughput of over 250 bytes per second which is sufficient to practice the invention.

The previous description is of a preferred embodiment for implementing the invention, and the scope of the invention should not necessarily be limited by this description. The scope of the present invention is instead defined by the following claims.

What is claimed is:

1. A brake controller system comprising:
brakes located on a towed vehicle;
a brake activator for applying force to said brakes;
a brake control unit in communication with said brake activator, said brake control unit having a CPU;
a battery in electrical communication with said brake control unit for supplying power to said brake control unit;
voltage regulation circuitry in electrical communication with said brake control unit;
said CPU in electrical communication with a bus that is in communication with at least said brake activator; and
a voltage booster in electrical communication with said battery and with said brake activator.

2. The brake controller system according to claim 1 wherein said brakes are electric brakes.

3. The brake controller system according to claim 1 further comprising:
a towing vehicle having a towing vehicle brake system for operating towing vehicle brakes, said towing vehicle brake system having a master cylinder.

4. The brake controller system according to claim 1 wherein:
said brake activator is comprised of magnets; and
a current sensor for maintaining constant amperage to the towed vehicle brakes.

5. The brake controller system according to claim 4 wherein:
said CPU adjusts a signal for brake activation, based at least partially on data from said current sensor.

6. The brake controller system according to claim 3 further comprising:
a pressure sensor in said towing vehicle master cylinder for measuring the pressure of brake fluid within said towing vehicle brake system.

7. The brake controller system according to claim 1 wherein:
wherein said brake control unit is located within a towing vehicle

8. The brake controller system according to claim 1 wherein:
said bus communicates said CPU with brake lights on said towing vehicle.

9. The brake controller system according to claim 1 wherein
said bus communicates said CPU with a pressure sensor positioned proximate a master cylinder of said towed vehicle.

10. The brake controller system according to claim 1 wherein
said bus is a brake wire that receives multiplexed signals.

11. The brake controller system according to claim 1 further comprising:
a display on a front face of said brake controller unit and in communication with said CPU for use as a visual indicator to an operator.

12. The brake controller system according to claim 1 further comprising:
a control panel on said brake controller unit comprising an adjust selection display down button, and adjust selection display up button, an enter selection displayed button and a scroll menu button.

13. The brake controller system according to claim 1 further comprising:
a manual thumb brake switch on brake controller unit for manually operating said brakes.

14. A method for operating a brake controller system comprising the steps of:
signaling a voltage booster to supply additional voltage above a towing vehicle standard voltage; and
actuating the towed vehicle brakes.

15. The method for operating a brake controller system comprising the steps of:
sensing brake fluid pressure within a towing vehicle brake system with a pressure sensor;
sensing current in an electric brake system;
calculating with a brake controller unit the appropriate amount of brake force to be applied by said brake activator;
determining whether a voltage booster is required to supply additional voltage to said towing vehicle brake system;
applying an appropriate amount of brake force with an appropriate amount of voltage as directed by said brake controller unit.

16. The method for operating a brake controller system according to claim 15 further comprising the steps of:
signaling brake lights and a brake activator with said brake controller unit over a brake line by multiplexing signals over said brake line.

17. The method for operating a brake controller system according to claim 15 further comprising the steps of:
actuating towed vehicle brakes without actuating towing vehicle brakes by use of a manual thumb brake switch,
generating a signal from said brake controller unit that is based upon and directly proportional to a linear position of the manual thumb brake switch; and
activating said brake activator with said signal.

18. The method for operating a brake controller system according to claim 15 further comprising the steps of:
storing data within a CPU of said brake controller system;
displaying at least a portion of said data with an alphanumeric display as a visual indicator to the vehicle operator during operation of the brake controller;
wherein said data is selected from a group comprising: Brake Gain; Time; Date; Last Maximum Brake; Last Maximum Stroke; Last Test: Maximum Brake; Last Test: Maximum Stroke; Truck Control: Serial Number; Truck Control: Date Manufactured; Truck Control; Born on Date; Trailer Control: Serial Number; Trailer Control: Date Manufactured; Trailer Control: Born on Date; Run Diagnostic: Test Brakes.
